(19) United States
(12) Patent Application Publication
(10) Pub. No.: US 2009/0220146 A1
(43) Pub. Date: Sep. 3, 2009

(54) METHOD AND APPARATUS FOR CHARACTERIZING THE FORMATION OF PAPER

(76) Inventors: Armin Bauer, St. Polten (AT); Marianne Kiniger, Wien (AT)

Correspondence Address: TAYLOR & AUST, P.C., P.O. Box 560, 142. S Main Street, Avilla, IN, 46710, US

(21) Appl. No.: 12/394,597

(22) Filed: Feb. 27, 2009

(30) Foreign Application Priority Data
Mar. 1, 2008 (DE) 10 2008 012 152.5

(51) Int. Cl. G06K 9/66

(52) U.S. Cl. 382/159

(57) ABSTRACT

A method for characterizing the formation of paper in which patterns and/or structures existing in the paper are automatically characterized and classified. The automatic characterization and classification includes creating a collection of paper specimens, creating a digital image of each individual specimen, digital pre-processing of the digital image where necessary, calculating different multi-dimensional features in light of the digital images or sub-ranges of the images, analyzing structure-specific groups forming in the feature space during calculation of the different multi-dimensional features and analyzing the structure-specific groups in the feature space, projecting the results of the analysis of the structure-specific groups into a—compared to the feature space—low-dimensional space for visualizing the analysis results, and drawing on the analysis results for the classification of newly added specimens. The calculation of the different multi-dimensional features takes place in light of the digital images or sub-ranges of the images on the basis of at least one of the following algorithms: relational kernel function (RKF), phase-based method, 2-point or 3-point method, or wavelets.

### BACKGROUND OF THE INVENTION

1. Field of the Invention

The present invention relates to a method and apparatus for characterizing the formation of paper by means of at least one image processing method with which patterns and/or structures existing in the paper are automatically characterized and classified.

2. Description of the Related Art

The formation of paper comes about through slight, irregular deviations of the gsm substance due to flocculation of the fibers. The quality parameters of the produced paper, for example, its printability, breaking length, porosity etc., depend largely on the formation. It is customary for the formation to be evaluated objectively using an index, such as “Ambertec”, or subjectively on a light table.

Another possibility for characterizing the formation of paper is automatic characterization by means of pattern and structure identification (see for example WO 2004/023398 A1). In this case different formation ranges are differentiated objectively in the light of their characteristic structure through the use of certain classification algorithms. The procedure for such automatic characterization and classification of specimens is known in principle, for example, from WO 2004/023398 A1. It usually includes the following steps:

1. Collection of specimens:
Creating a collection of specimens, also called a training set, which contains a representative number of as many different texture types as possible.

2. Digitalization: A digital image is created of each individual specimen.

3. Extraction of features:
Different multi-dimensional features are calculated from the images. The features are obtained from algorithms which are applied to the image itself or to sub-ranges of the image. The choice of features is of decisive importance for the structure identification process. Suitable features enable better differentiability between the structures occurring in the collection of specimens than is possible with the original images. In the high-dimensional feature space there is a smaller distance between features of similar structures than between features of different structures. Structure-specific groups, so-called structure clusters, thus form in the feature space.

4. Analysis of the cluster formation:
The multi-dimensional features serve as input parameters for an algorithm which can be used to detect whether groups or clusters form in the high-dimensional feature space.

5. Visualization:
Finally, the result of the cluster analysis is projected into a low-dimensional space, taking care to preserve the group as much as possible. This means that, on the one hand, the distance between specimens with similar features in the low-dimensional projection is small and that, on the other hand, the distance between specimens with very different features is large. Such an algorithm is, for example, a self-organizing map (SOM). The projection also enables visualization of the cluster analysis results.

6. Assignment of newly added specimens:
The results of the cluster analysis can be drawn on for classification of newly added specimens. This is also referred to as classificatory training. A new specimen whose feature was calculated can be assigned to a certain cluster and, hence, be classified.

7. Assignment of specimens to a defined class (optional):
The classifier can be extended by defining, either prior to or after the analysis, classes to which the specimens belong. A newly added specimen can be classified on the basis of the class affiliation of those specimens from the training set which form a cluster.

8. Adaptation of the classifier (optional):
A newly added specimen can be added to the training set. Through re-training of the classifier the latter can be adapted such that any arising formation structures which were not included in the original training set can be classified.

With the method for characterizing the formation of paper known from WO 2004/023398 A1, so-called local binary patterns (LBPs) of various forms are used in the previously mentioned step 3 (extraction of features) of the characterization process. In this case, the pixels in a defined neighborhood around a central pixel are examined in order to calculate the LBP texture feature. Here, the gray-scale value differences between the central pixel and its neighboring pixels are summarized in simplified terms in binary numbers. An example of this type of calculation method can be found in FIG. 1, whereby the calculation of the binary numbers is based on the following equation:

$$L B P ( m ) = {\sum }_{i = 1}^{8} κ ( {m}_{i} ) {2}^{i - 1} , κ ( {m}_{i} ) = \{ \begin{matrix}1 , & for {m}_{i} \geq {m}_{0} \\ 0 , & otherwise\end{matrix} \\ m = {( {m}_{0} , {m}_{1} , … , {m}_{8} )}^{T}$$

In the case presented in FIG. 1, the central point of the 3×3 neighborhood (here value 3) is compared with the pixels surrounding it and is coded as a binary number.

As is clear from FIG. 2, the original 3×3 environment of every pixel can be expanded to neighborhoods of any size. In this case, FIG. 2 presents examples of the expansion of the LBP operator to radii R of any size. Gray-scale values of the circular neighborhood which do not coincide exactly with the center of a pixel are interpolated. There exist various versions of the LBP operator including, for example, a rotation-invariant version.

FIG. 3 illustrates the results of the known cluster formation based on the various formation types using local binary patterns (LBPs) and a self-organizing map (SOM). Here, there exists, according to FIG. 3, a reduced representation of a self-organizing map (SOM) on which 25 nodes existing a regular distance from each other were selected from 625 nodes of a self-organizing map (SOM) with respectively 25 rows and columns. Each presented node is represented by a paper specimen from the training set. As previously mentioned, a local binary pattern (LBP) was used here as the feature algorithm. An important goal of the formation analysis is to predict, in the light of the formation, paper characteristics which are closely linked to the formation, for example, printability or porosity.

It has been found that the use of such local binary patterns (LBPs) results in only a low correlation of formation types arising within a cluster with physical quality parameters, as is also evident, for example, in FIGS. 4 and 5. FIG. 4 shows ash content values assigned to the individual nodes of a self-organizing map (SOM), whereby a local binary pattern (LBP) was selected as the feature. FIG. 5 shows values for the elongation in longitudinal direction assigned to the individual nodes of a self-organizing map (SOM), whereby a local binary pattern (LBP) was again selected as the feature.

What is needed in the art is an improved method and apparatus to enable a better classification of the paper structure than is the case when using local binary patterns (LBPs). In particular, the given correlation with physical paper characteristics should also be as good as possible in this case.

### SUMMARY OF THE INVENTION

The present invention provides a method wherein the calculation of the different multi-dimensional features takes place in light of the digital images or sub-ranges of the images on the basis of at least one of the following algorithms:
relational kernel function (RCF);
phase-based method;
2-point or 3-point method;
wavelets.
   It is thus possible to use individual or random combinations of two or more of the named algorithms.

The analysis of the structure-specific groups in the feature space may be performed by a classifier including, in particular, a self-organizing map (SOM). In this case, the classifier, for example, the self-organizing map (SOM), is trained with a sufficiently large number of paper specimens containing a representative number of the various formation types. Various formation ranges can be defined in the classifier, either by specimens which were assigned before the training to various classes or else after the training. For the classification of newly imaged paper specimens, the specimens can be analyzed in the classifier, for example on the self-organizing map (SOM). Here, it is also possible for the analysis to take place online.

The digital images of the paper specimens may be saved in an archive whereby their coordinates can be determined in the previously trained classifier, for example, the self-organizing map (SOM). With each digital image of a respective paper specimen it is expedient to save the image creation time and at least one assigned quality parameter which was measured empirically or online. Hence, it is also possible with the method of the present invention to analyze the time-related development of certain formation characteristics within definable time intervals. The remaining steps can correspond at least essentially to the respective steps of the method known from WO 2004/023398 A1.

Relational kernel functions are described, for example, in Schael, M.: “Invariant Texture Classification Using Group Averaging with Relational Kernel Functions”, In Texture 2002 the 2nd International Workshop on Texture Analysis and Synthesis, pages 129-134, June 2002, which is incorporated herein.

In this case, the average of the gray-scale value difference δ of two concentric circles around the pixel is mapped on the real-value interval [0, 1] in order to calculate the relational kernel function, where:

$$rel \text{:} I -> [ 0 , 1 ] , rel ( δ ) = \{ \begin{matrix}1 & for δ < - \frac{ɛ}{2} \\ \frac{1}{2 ɛ} ( ɛ - 2 δ ) , & for - \frac{ɛ}{2} \leq δ \leq \frac{ɛ}{2} \\ 0 & for δ < \frac{ɛ}{2}\end{matrix}$$

For ε=0, rel(δ) is a step function and invariant with regard to strictly monotonical gray-scale value transformations. If ε>0, the invariance is lost which, in this case, means that the feature is more robust to noise.

The phase-based method is described, for example, in Fehr, J., Burkhardt, H.: “Phase-based 3D Texture Features”, Proceedings of the 28th Pattern Recognition Symposium of the German Association for Pattern Recognition (DAGM 2006), Berlin, Germany, LNCS, Springer (2006), 263-372. The basis of the algorithm on which the phase-based method is based is the representation of a signal in the three-dimensional space on a sphere around a point of the data set as the sum of spherical surface functions. The analogy in the two-dimensional space is the signal's representation on a circle. A circle with the radius r is calculated for the angle Φ and the band I in accordance with the following relationship:

$${S}_{lq} ( r , φ ) = \{ \begin{matrix}{e}^{- i l φ} , & for = \vert q \vert \\ 0 , & otherwise\end{matrix}$$

The band-wise relationships of the phases Slq between two different concentric circles are used to form the feature. After smoothing the data series of each circle with a Gaussian filter, the invariant texture feature T is calculated by applying a general kernel function f to the two circles with the radii r1 and r2:

T[f₁]:=f₁(Sₗᵣ₁,Sₗᵣ₂)

The feature is invariant with regard to monotonical gray-scale value transformations and rotations.

The 2-point or 3-point method is described for, example, in Ronneberger, O., Fehr, J., Burkhardt, H.: “Voxel-Wise Gray Scale Invariants for Simultaneous Segmentation and Classification”, In Proceedings of the 27th DAGM Symposium, in Number 3663 LNCS, Springer, Vienna, Austria (2005), which is accordingly incorporated herein.

The basis for the algorithm of this texture feature is formed by so-called Haar integrals. An invariant of the data series M is calculated as follows through integration via a transformation group G: M is transformed in accordance with all the elements of the group G. The kernel function f is then applied to each result. The group average A[f](M) is obtained through subsequent integration:

$$A [ f ] ( M ) = {\int }_{G} f ( g M ) d g$$

To be able to apply the algorithm to a digital image, a sum is calculated instead of the integral. The transformation group of the rotations is used to obtain the feature. For this purpose, the group average is calculated for each pixel. Here, the choice of kernel function is important. Fast calculation of the Haar integral is facilitated by applying the so-called Monte Carlo integration to a certain class of kernel functions, the 2-point or so-called 3-point kernel functions.

In connection with the wavelets, the wavelet coefficients obtained after a corresponding wavelet transformation of the image are used as basis for forming a feature vector. In this case, the procedure can be as follows: Using the discrete wavelet transformation the image is split into two parts. On the one hand, we get an approximated version of the image, on the other hand, the higher-frequency details in a chosen direction. If several directions are chosen, for example, horizontal, vertical and diagonal, then we get an approximated version and the details in the corresponding directions. The approximated image can then be split again as often as required in the same way. Finally, the texture feature can be compiled, for example, from the average values and standard deviations of the individual transformations.

The present invention enables a more exact determination of the formation by means of automatic pattern and structure detection. Also, the values of formation-dependent quality parameters can be better assessed.

The algorithms, which are used according to the present invention and form the basis for calculating the features, differentiate between the various types of formation among the paper specimens more greatly than the local binary patterns (LBPs) customary up to now. This applies, in particular, for a combination of two or more of the algorithms drawn on in accordance with the present invention. A clear differentiation between the various types of formation is thus obtained. This leads to a greater correlation of the physical quality parameters of the paper with the structure of the formation. Hence, the present invention permits a more differentiated automatic formation analysis and a reliable conclusion to be drawn from the formation with respect to the quality parameters. Consequently, it is possible to draw conclusions from other digital paper images with respect to exactly this quality feature.

Another advantage of the present invention is that it is possible to enter into the low-dimensional projection of the feature space the corresponding quality parameters which were measured, for example, empirically. It is thus possible to examine whether similar values of the quality parameters arise within a cluster determined with the self-organizing map (SOM).

The present invention provides an apparatus, for calculating the different multi-dimensional features in light of the digital images or sub-ranges of the images such that the calculation takes place on the basis of at least one of the following algorithms:
relational kernel function (RCF);
phase-based method;
2-point or 3-point method;
wavelets.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic representation of a known method for extracting features using local binary patterns (LBPs);

FIG. 2 shows examples of the expansion of the LBP operator to radii of any size;

FIG. 3 shows the results of a known cluster formation using local binary patterns (LBPs);

FIG. 4 shows ash content values assigned to the individual nodes of a self-organizing map (SOM), whereby a local binary pattern (LBP) was selected as the feature;

FIG. 5 shows values for the elongation in longitudinal direction assigned to the individual nodes of a self-organizing map (SOM), whereby a local binary pattern (LBP) was selected as the feature;

FIG. 6 shows a schematic representation of an arrangement for performing the method of the present invention for characterizing the formation of paper;

FIG. 7 shows a schematic representation of example circles for an inventive RKF calculation (RKF=Relational Kernel Function);

FIG. 8 shows a schematic representation of a wavelet decomposition;

FIG. 9 shows the results of cluster formation of the various formation types according to the present invention using the relational kernel function (RKF) to calculate the feature vectors;

FIG. 10 shows ash content values assigned to the individual nodes of a self-organizing map (SOM), whereby, for example, the phase-based method was selected as feature; and

FIG. 11 shows values for the elongation in longitudinal direction assigned to the individual nodes of a self-organizing map (SOM), whereby, for example, the relational kernel functions (RKF) were calculated as a feature in accordance with the present invention.

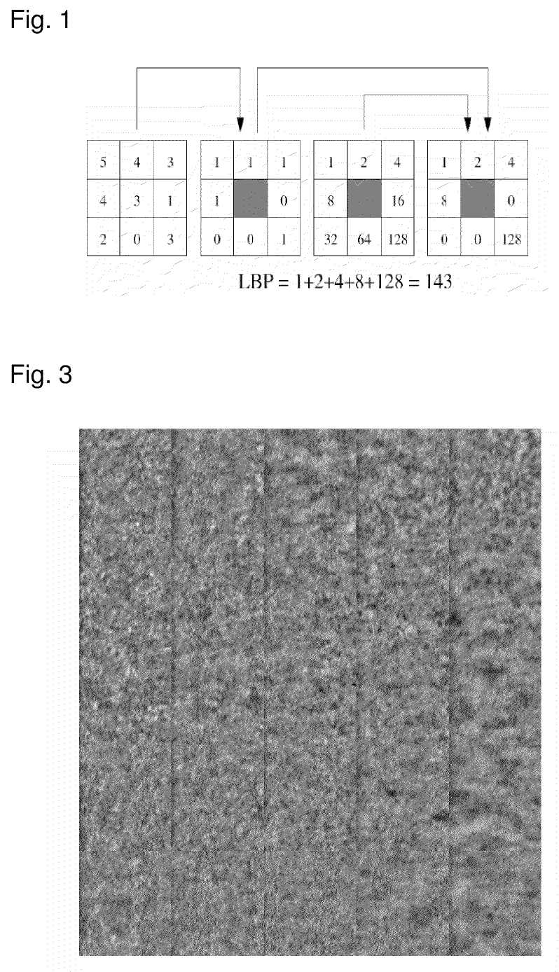

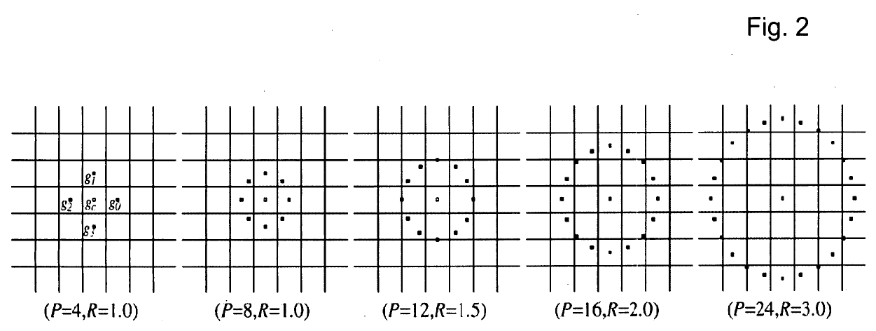

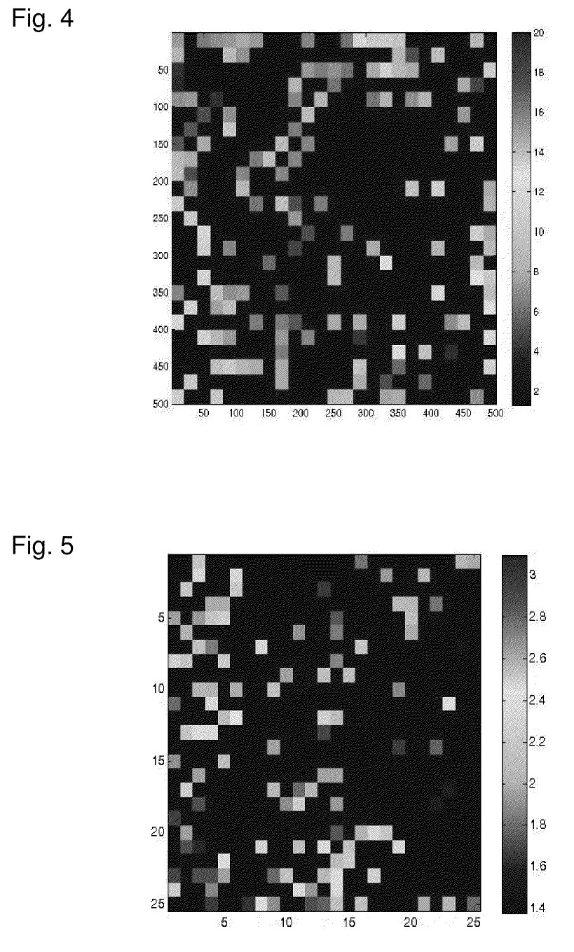

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

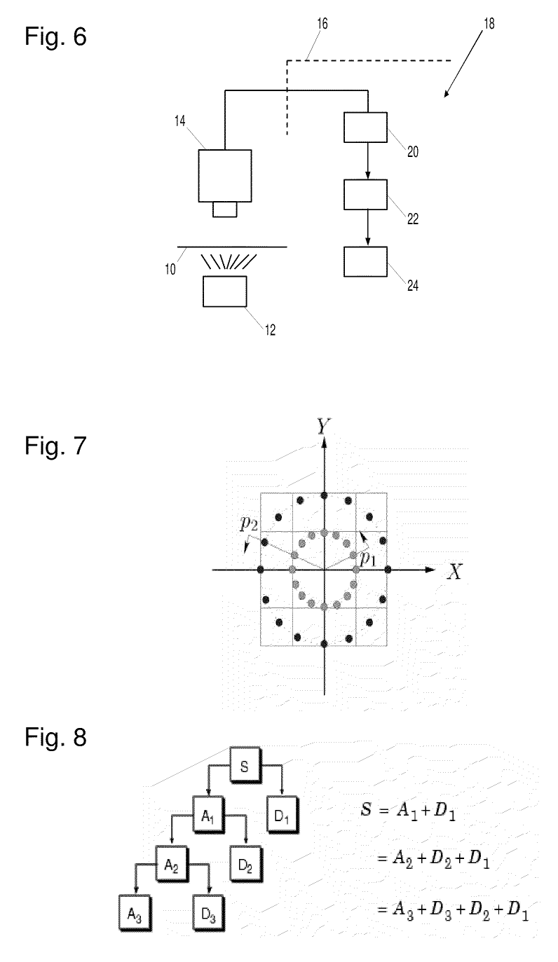

Referring now to the drawings, and more particularly to FIG. 6 there is shown a schematic representation of an arrangement for performing the method of the present invention for characterizing the formation of paper. In this case, paper web or paper sheet 10 is illuminated by means of light source 12, whereby, in the case in question, the web or sheet is illuminated by the backlighting method. Digital images of individual specimens are created using digital camera 14, whereby the images can be produced in the laboratory or online.

Digital camera 14 is connected via interface 16 to evaluation unit 18 which can include, for example, a computer. The digital image is saved in a memory 20 of evaluation unit 18. Evaluation unit 18 also includes means 22 for calculating the feature or texture feature in light of the data saved in memory 20. In addition, evaluation unit 18 includes means for classifying on the basis of the calculated texture feature by way of a classifier. Hence, it is possible, in principle, for the method of the present invention to be used on the paper machine or in the laboratory.

An embodiment of the method of the present invention includes the following steps:

1. Training of the classifier (SOM):
The digital pre-processing of the digital image can be performed either directly in the digital camera or in the evaluation unit. The training of a self-organizing map is performed with a sufficiently large number of paper specimens which contain representative numbers of the various formation types. In this case, it is also possible to extract the specimens online or in the laboratory. Finally, various formation ranges are defined on the map.

2. Classification of new paper specimens:
Newly imaged paper specimens are analyzed on the self-organizing map. On the one hand, this determines the structure of the formation, on the other hand, the values of the various quality parameters can be estimated provided the paper specimen is of the same sort as the training specimens. The analysis can be performed online, as is evident, for example, from FIG. 6.

3. Archive function:
The digital images of the paper specimens are saved in an archive. Through application of the feature algorithms it is possible at any time to determine the structure of the formation with the help of the previously trained classifier. The time and quality parameters measured empirically are saved with each image. Hence, it is also possible to analyze the time-related development of the formation within random time intervals.

In FIG. 7 there is shown a schematic representation of example circles for an RKF calculation (RKF=Relational Kernel Function) according to the present invention. The average of the gray-scale value difference δ of two concentric circles around the pixel is mapped on the real-value interval [0.1, 1], where:

$$rel \text{:} I -> [ 0 , 1 ] , rel ( δ ) = \{ \begin{matrix}1 & for δ < - \frac{ɛ}{2} \\ \frac{1}{2 ɛ} ( ɛ - 2 δ ) , & for - \frac{ɛ}{2} \leq δ \leq \frac{ɛ}{2} \\ 0 & for δ < \frac{ɛ}{2}\end{matrix}$$

For ε=0, rel(δ) is a step function and invariant with regard to strictly monotonical gray-scale value transformations. If ε>0, said invariance is lost, which, however in this case, means that the feature is more robust to noise. In FIG. 8 there is shown a schematic representation of a wavelet decomposition. In this case, the wavelet coefficients obtained after a wavelet transformation of the image are used as basis for forming a feature vector. As is evident from FIG. 8, the procedure can be as follows: Using the discrete wavelet transformation the image is split into two parts. On the one hand, we get an approximated version of the image, on the other hand, the higher-frequency details in a chosen direction. If several directions are chosen, for example, horizontal, vertical and diagonal, then we get an approximated version and the details in the corresponding directions. The approximated image can then be split again as often as required in the same way. Finally, the texture feature can be compiled, for example, from the average values and standard deviations of the individual transformations. Hence, in the wavelet decomposition reproduced in FIG. 8, the signal S is split into its approximation and details. For a two-dimensional signal the details may be determined in the three directions horizontal, vertical and diagonal. The image thus approximated can be split again.

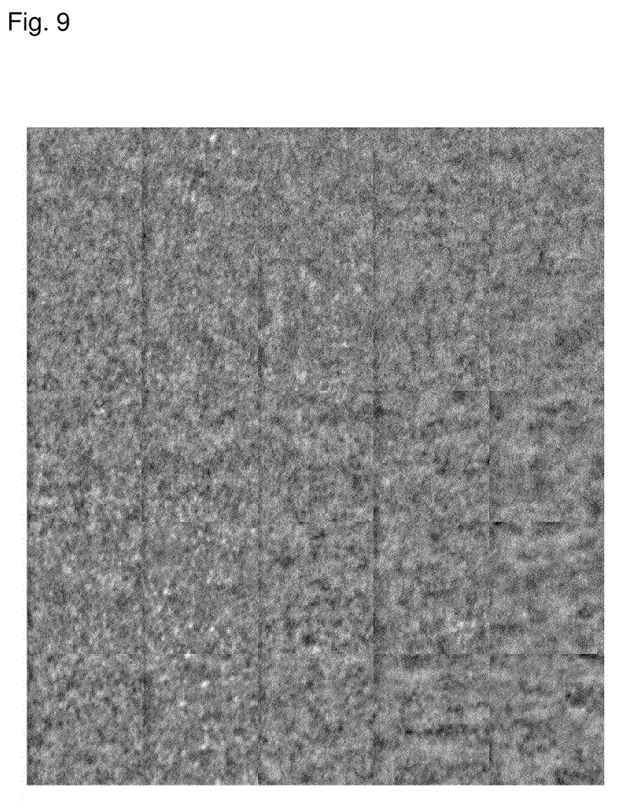

In FIG. 9 there is shown the results of an inventive cluster formation using the relational kernel function (RKF) to calculate the feature vectors. Here, 25 nodes existing a regular distance from each other are selected from 625 nodes of the self-organizing map (SOM) with respectively 25 rows and columns for a reduced representation of a self-organizing map (SOM). Each presented node is represented by a paper specimen from the training set. Recognizable at bottom right is a region with a rough cloud-like formation. On the left are white dots and at center top right the formation is very fine and homogeneous. As previously mentioned, the relational kernel functions (see also FIG. 11) were used as the algorithm for calculating the feature vectors.

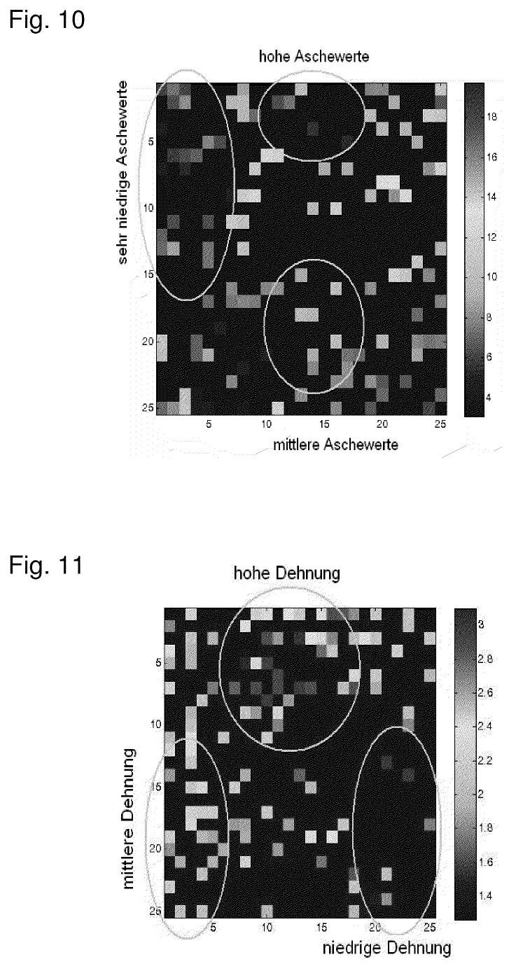

In FIG. 10 shown ash content values assigned to the individual nodes of a self-organizing map (SOM) whereby, for example, the phase-based method was selected as feature in accordance with the present invention. As is evident from FIG. 10, the result is a relatively high correlation of the physical quality parameters of the paper with the structure of the formation.

FIG. 11 illustrates values for the elongation in longitudinal direction assigned to the individual nodes of a self-organizing map (SOM) whereby, for example, the relational kernel functions (RKF) were calculated as feature in accordance with the present invention. Again, it is evident from this figure that the physical quality parameters correlate more highly with the clusters.

While the present invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

10 Paper web, paper sheet

12 Light source

14 Digital camera

16 Interface

18 Evaluation unit

20 Memory

22 Means for calculating the texture feature

24 Means for classifying

What is claimed is:

1. A method for characterizing the formation of paper in which at least one of patterns and structures existing in the paper are automatically characterized and classified, the method comprising the steps of:
creating a collection of individual paper specimens;
creating a digital image of each of said individual paper specimens;
calculating different multi-dimensional features in light of one of said digital images and sub-ranges of said digital images;
analyzing structure-specific groups forming in a feature space during said calculating step;
analyzing said structure-specific groups in said feature space;
projecting results of said analyzing step into a lower dimensional space than said feature space for visualizing said results of said analyzing step;
adding a new specimen;
classifying said newly added specimens in light of said results of said analyzing step;
wherein said calculating step takes place in consideration of one of said digital images and said sub-ranges of said digital images based on at least one algorithm, said at least one algorithm including:
a relational kernel function;
a phase-based method;
a 2-point or 3-point method; and
wavelets.

2. The method according to claim 1, further comprising the step of digitally pre-processing said digital image.

3. The method according to claim 1, wherein said analyzing step is performed using a classifier.

4. The method according to claim 3, wherein said classifier is a self-organizing map.

5. The method according to claim 4, further comprising the step of training one of said classifier and said self-organizing map with a substantially large number of paper specimens containing a representative number of different formation types.

6. The method according to claim 5, further comprising the step of defining a plurality of formation ranges from said formation types in one of said classifier and said self-organizing map.

7. The method according to claim 6, wherein said newly added specimen is analyzed in one of said classifier and said self-organizing map.

8. The method according to claim 7, wherein said analyzing step takes place online.

9. The method according to claim 8, wherein said digital image of each of said individual paper specimens is saved in an archive, each of said digital images having coordinates configured to be determined by one of said classifier and said self-organizing map subsequent to said training step.

10. The method according to claim 9, further comprising the step of saving an image creation time and at least one assigned quality parameter for each of said digital images.

11. The method according to claim 10, wherein said at least one assigned quality parameter is determined empirically.

12. The method according to claim 11, further comprising the step of analyzing time-related development of said formation within predefined time intervals.

13. An apparatus for characterizing the formation of paper in which at least one of patterns and structures existing in the paper are automatically characterized and classified, said apparatus being configured for:
creating a collection of individual paper specimens;
creating a digital image of each of said individual paper specimens;
calculating different multi-dimensional features in light of one of said digital images and sub-ranges of said digital images;
analyzing structure-specific groups forming in a feature space during said calculating step;
analyzing said structure-specific groups in said feature space;
projecting results of said analyzing step into a lower dimensional space than said feature space for visualizing said results of said analyzing step;
adding a new specimen;
classifying said newly added specimens in light of said results of said analyzing step;
wherein said calculating step takes place in consideration of one of said digital images and said sub-ranges of said digital images based on at least one algorithm, said at least one algorithm including:
a relational kernel function;
a phase-based method;
a 2-point or 3-point method; and
wavelets.
